(19) United States
(12) Patent Application Publication
(10) Pub. No.: US 2025/0044614 A1
(43) Pub. Date: Feb. 6, 2025

(54) OPHTHALMIC LENS WITH MICROLENSES FOR THERAPEUTIC MANAGEMENT

(71) Applicant: HOYA Optical Labs of America, Inc., Lewisville, TX (US)

(72) Inventor: Ryan Knutson, Ramsey, MN (US)

(73) Assignee: HOYA Optical Labs of America, Inc., Lewisville, TX (US)

(21) Appl. No.: 18/791,312

(22) Filed: Jul. 31, 2024

Related U.S. Application Data
(60) Provisional application No. 63/516,809, filed on Jul. 31, 2023.

(51) Int. Cl. G02C 7/02

(52) U.S. Cl. CPC G02C 7/022; G02C 2202/10

(57) ABSTRACT

The present specification includes eyeglasses comprising an eyeglass frame, a first ophthalmic lens incorporating a plurality of microlenses designed to induce blur for the wearer, and a second ophthalmic lens devoid of microlenses. The eyeglasses may provide a unique optical configuration where the first lens introduces intentional blur effects while the second lens may remain free of microlenses, offering therapeutic management or treatment for some medical conditions.

### RELATED APPLICATIONS

This application claims benefit of and priority to U.S. Provisional Application Ser. No. 63/516,809 filed Jul. 31, 2023 entitled Ophthalmic Lens with Microlenses for Therapeutic Treatment, which is hereby incorporated herein by reference in its entirety.

### BACKGROUND

Amblyopia is a disorder of sight in which the brain fails to fully process input from one eye and over time favors the other eye. It results in decreased vision in an eye that typically appears normal in other respects. Amblyopia is the most common cause of decreased vision in a single eye among children and younger adults.

The cause of amblyopia can be any condition that interferes with focusing, typically during early childhood. This can occur from poor alignment of the eyes (strabismic), an eye being irregularly shaped such that focusing is difficult, one eye being more nearsighted or farsighted than the other (refractive), or clouding of the lens of an eye (deprivational).

Amblyopia typically has three main causes: strabismic (misaligned eyes), refractive (difference of a certain degree of nearsightedness, farsightedness, or astigmatism) or by significant amount of equal refractive error in both eyes, or deprivational by deprivation of vision early in life by vision-obstructing disorders such as congenital cataract.

Strabismic amblyopia and refractive amblyopia are typically treated by clarifying the visual image with glasses or encouraging use of the amblyopic eye with an eyepatch over the dominant eye or pharmacologic penalization of the better eye. Penalization usually consists of applying atropine drops to temporarily paralyze the accommodation reflex, leading to the blurring of vision in the good eye. It also dilates the pupil. This helps to prevent the bullying and teasing associated with wearing a patch, although sometimes application of the eye drops is challenging.

Another common eye disorder is dry eye syndrome, also known as keratoconjunctivitis sicca, which is the condition of having dry eyes. Other associated symptoms include irritation, redness, discharge, blurred vision, and easily fatigued eyes.

Typically, dry eye syndrome occurs when either the eye does not produce enough tears or when the tears evaporate too quickly. This can result from a range of causes, such as contact lens use, meibomian gland dysfunction, pregnancy, Sjögren syndrome, vitamin A deficiency, omega-3 fatty acid deficiency, LASIK surgery, and certain medications such as antihistamines, some blood pressure medication, hormone replacement therapy, and antidepressants. Treatment for dry eye syndrome depends on the underlying cause. Artificial tears are typically the first line of treatment.

Healthy individuals typically blink about 10-15 times per minute. With each blink, the eye's tear film is renewed, which protects and moisturizes the eye. The tear film consists of three sublayers: mucus, watery and oil layer at the top, which protects the eye from dryness (water evaporation).

Because blinking coats the eye with tears, dry eye syndrome symptoms are typically worsened by activities in which the rate of blinking is reduced due to prolonged use of the eyes. These activities include prolonged reading, computer usage (computer vision syndrome), driving, or watching television. Hence, it can be beneficial to increase an individual's rate of blinking to help treat dry eye syndrome and similar disorders.

### SUMMARY

In some aspects, the techniques described herein relate to an ophthalmic lens assembly for managing eye conditions, including: a first ophthalmic lens including a plurality of microlenses integrated with the first ophthalmic lens; where each of the plurality of microlenses modify a focus of light; and, a frame connected to the first ophthalmic lens; wherein the frame positions the plurality of microlenses substantially in front of only a first eye of a user and wherein the plurality of microlenses defocus light relative to a retina of the first eye of the user.

In some aspects, the techniques described herein relate to an ophthalmic lens assembly, wherein the plurality of microlenses is configured to focus light closer to a front side of a user's retina to reduce visual acuity.

In some aspects, the techniques described herein relate to an ophthalmic lens assembly, wherein the plurality of microlenses is configured to focus light further from a front side of a user's retina to reduce visual acuity.

In some aspects, the techniques described herein relate to an ophthalmic lens assembly, wherein the plurality of microlenses is arranged in repeating patterns, where each of the repeating patterns include a ring shape, a filled circle shape, a filled triangle shape, or a filled square shape.

In some aspects, the techniques described herein relate to an ophthalmic lens assembly, wherein the plurality of microlenses are arranged in a grid pattern, a random or stochastic pattern, a spiral pattern, a checkerboard pattern, a clustered pattern, a fractal pattern, a triangular lattice pattern, or a honeycomb pattern.

In some aspects, the techniques described herein relate to an ophthalmic lens assembly, wherein the plurality of microlenses have a diameter within an inclusive range of about 0.25 to 2.0 mm.

In some aspects, the techniques described herein relate to an ophthalmic lens assembly, wherein at least some of the plurality of microlenses are spaced apart from each other at a distance of about 0 to 2.0 mm measured from center points of the plurality of microlenses.

In some aspects, the techniques described herein relate to an ophthalmic lens assembly, wherein a ratio of an area of the first ophthalmic lens without the microlenses to the area of the first ophthalmic lens without the microlenses is within an inclusive range of about 0 percent to 25 percent.

In some aspects, the techniques described herein relate to an ophthalmic lens assembly, wherein a ratio of an area of the first ophthalmic lens without the microlenses to the area of the first ophthalmic lens without the microlenses is about 12 percent, plus-or-minus 2 percent.

In some aspects, the techniques described herein relate to an ophthalmic lens assembly, wherein the plurality of microlenses are each configured to have a defocus power achieving a visual acuity value of 0.3 or less.

In some aspects, the techniques described herein relate to an ophthalmic lens assembly, wherein the plurality of microlenses are each configured to have a defocus power achieving a visual acuity value of 0.1 or less.

In some aspects, the techniques described herein relate to an ophthalmic lens assembly, wherein the plurality of microlenses include spherical shaped microlenses, aspherical shaped microlenses, or a combination of both.

In some aspects, the techniques described herein relate to an ophthalmic lens assembly, wherein the plurality of microlenses are located on a front surface of the first ophthalmic lens, a back surface of the first ophthalmic lens, both the front and back surfaces of the first ophthalmic lens, between layers of the first ophthalmic lens, or within material of the first ophthalmic lens.

In some aspects, the techniques described herein relate to an ophthalmic lens assembly, further including a second ophthalmic lens connected to the frame; wherein the second ophthalmic lens is free of any microlenses.

In some aspects, the techniques described herein relate to an ophthalmic lens assembly, wherein the frame is configured to position the first ophthalmic lens in front of a stronger eye of a wearer and wherein the second ophthalmic lens is positioned in front of a weaker amblyopic eye of the wearer.

In some aspects, the techniques described herein relate to an ophthalmic lens assembly, further including a second ophthalmic lens connected to the frame; wherein the plurality of microlenses is part of both the first ophthalmic lens and the second ophthalmic lens.

In some aspects, the techniques described herein relate to an ophthalmic lens assembly, wherein the plurality of microlenses is arranged in a plurality of groups of microlenses on the first ophthalmic lens and the second ophthalmic lens.

In some aspects, the techniques described herein relate to an ophthalmic lens assembly, wherein the plurality of groups of microlenses have a size within an inclusive range of about 6 mm to about 25 mm.

In some aspects, the techniques described herein relate to an ophthalmic lens assembly, wherein the plurality of groups of microlenses are arranged in a ring shape on the first ophthalmic lens and the second ophthalmic lens.

In some aspects, the techniques described herein relate to an ophthalmic lens assembly, wherein the plurality of groups of microlenses are arranged on only a lower half of the first ophthalmic lens and the second ophthalmic lens.

In some aspects, the techniques described herein relate to an ophthalmic lens assembly, wherein the plurality of groups of microlenses are arranged on only an inner portion of the first ophthalmic lens and the second ophthalmic lens, relative to a middle of the frame.

In some aspects, the techniques described herein relate to an ophthalmic lens assembly, wherein the plurality of groups of microlenses are arranged on only inner and lower portions of the first ophthalmic lens and the second ophthalmic lens, relative to a middle of the frame.

In some aspects, the techniques described herein relate to an ophthalmic lens assembly, wherein an area of the first ophthalmic lens further includes ophthalmic dyes, scattering centers, and/or meta structures.

In some aspects, the techniques described herein relate to an ophthalmic lens assembly, wherein the plurality of microlenses further include ophthalmic dyes, scattering centers, and/or meta structures.

In some aspects, the techniques described herein relate to eyeglasses for managing eye conditions, including: a first ophthalmic lens including a plurality of microlenses integrated with the first ophthalmic lens; where each of the plurality of microlenses modify a focus of light; and, a second ophthalmic lens that is substantially free of microlenses; an eyeglass frame connected to the first ophthalmic lens and the second ophthalmic lens.

In some aspects, the techniques described herein relate to eyeglasses for managing eye conditions, including: a first ophthalmic lens; a second ophthalmic lens that is substantially free of microlenses; a plurality of microlenses integrated with the first ophthalmic lens and the second ophthalmic lens. an eyeglass frame connected to the first ophthalmic lens and the second ophthalmic lens.

In some aspects, the techniques described herein relate to a method of managing or treating an eye condition including: determining an amblyopic eye and a non-amblyopic eye of a patient; and, placing a first ophthalmic lens in front of the non-amblyopic eye, where the first ophthalmic lens defocuses light to the non-amblyopic eye with a plurality of microlenses.

In some aspects, the techniques described herein relate to a method, wherein the plurality of microlenses are configured to focus light closer to a front side of a user's retina to reduce visual acuity.

In some aspects, the techniques described herein relate to a method, wherein the plurality of microlenses are configured to focus light further from a front side of a user's retina to reduce visual acuity.

In some aspects, the techniques described herein relate to a method, wherein the plurality of microlenses are arranged in repeating patterns, where each of the repeating patterns include a ring shape, a filled circle shape, a filled triangle shape, or a filled square shape.

In some aspects, the techniques described herein relate to a method, wherein the plurality of microlenses are arranged in a grid pattern, a random or stochastic pattern, a spiral pattern, a checkerboard pattern, a clustered pattern, a fractal pattern, a triangular lattice pattern, or a honeycomb pattern.

In some aspects, the techniques described herein relate to a method, wherein the plurality of microlenses have a diameter within an inclusive range of about 0.25 to 2.0 mm.

In some aspects, the techniques described herein relate to a method, wherein at least some of the plurality of microlenses are spaced apart from each other at a distance of about 0 to 2.0 mm measured from center points of the plurality of microlenses.

In some aspects, the techniques described herein relate to a method, wherein a ratio of an area of the first ophthalmic lens without the microlenses to the area of the first ophthalmic lens without the microlenses is within an inclusive range of about 0 percent to 25 percent.

In some aspects, the techniques described herein relate to a method, wherein a ratio of an area of the first ophthalmic lens without the microlenses to the area of the first ophthalmic lens without the microlenses is about 12 percent, plus-or-minus 2 percent.

In some aspects, the techniques described herein relate to a method, wherein the plurality of microlenses is configured to have a defocus power achieving a visual acuity value of 0.3 or less.

In some aspects, the techniques described herein relate to a method, wherein the plurality of microlenses is configured to have a defocus power achieving a visual acuity value of 0.1 or less.

In some aspects, the techniques described herein relate to a method, wherein the plurality of microlenses include spherical shaped microlenses, aspherical shaped microlenses, or a combination of both.

In some aspects, the techniques described herein relate to a method, wherein the plurality of microlenses are located on a front surface of the first ophthalmic lens, a back surface of the first ophthalmic lens, both the front and back surfaces of the first ophthalmic lens, between layers of the first ophthalmic lens, or within material of the first ophthalmic lens.

In some aspects, the techniques described herein relate to a method, further including placing a second ophthalmic lens in front of the amblyopic eye, where the second ophthalmic lens allows focus of light on a retina of the patient.

In some aspects, the techniques described herein relate to a method of managing or treating an eye condition including: placing at least a first ophthalmic lens in front of an eye of a patient, where the first ophthalmic lens includes a plurality of microlenses that is arranged in a plurality of groups of microlenses to thereby generate a blink response from at least a first eye of the patient.

In some aspects, the techniques described herein relate to a method, wherein the plurality of groups of microlenses have a size within an inclusive range of about 6 mm to about 25 mm.

In some aspects, the techniques described herein relate to a method, further including placing a second ophthalmic lens in front of another eye of a patient, where the second ophthalmic lens also includes the plurality of groups of microlenses.

In some aspects, the techniques described herein relate to a method, wherein the plurality of groups of microlenses are arranged in a ring shape on the at least first ophthalmic lens.

In some aspects, the techniques described herein relate to a method, wherein the plurality of groups of microlenses are arranged on only a lower half of the first ophthalmic lens, relative to a nose of the patient.

In some aspects, the techniques described herein relate to a method, wherein the plurality of groups of microlenses are arranged on only an inner portion of the first ophthalmic lens, relative to a nose of the patient.

In some aspects, the techniques described herein relate to a method, wherein the plurality of groups of microlenses are arranged on only inner and lower portions of the first ophthalmic lens, relative to a nose of the patient.

In some aspects, the techniques described herein relate to a method, wherein an area of the first ophthalmic lens further includes ophthalmic dyes, scattering centers, and/or meta structures.

In some aspects, the techniques described herein relate to a method, wherein the plurality of microlenses further include ophthalmic dyes, scattering centers, and/or meta structures.

### BRIEF DESCRIPTION OF THE DRAWINGS

The following figures are included to illustrate certain example aspects of the present disclosure and should not be viewed as exclusive or limiting. The subject matter disclosed is capable of considerable modifications, alterations, combinations, and equivalents in form and function, as will occur to one having ordinary skill in the art and having the benefit of this disclosure. The present disclosure references the drawings as follows:

FIG. 1 is an example of eyeglasses with an array of microlenses according to one example.

FIG. 2 is an example of eyeglasses with an array of microlenses according to one example.

FIG. 3 is an example of eyeglasses with a plurality of groups of microlenses according to one example.

FIG. 4A is a magnified view of an ophthalmic lens with a plurality of groups of microlenses according to one example.

FIG. 4B is a magnified view of an ophthalmic lens with a plurality of groups of microlenses according to one example.

FIG. 5 is a magnified view of an ophthalmic lens with a plurality of groups of microlenses according to one example.

FIG. 6 is a view of an ophthalmic lens with microlenses according to one example.

FIG. 7 is a view of an ophthalmic lens with microlenses according to one example.

FIG. 8 is a view of an ophthalmic lens according to one example.

FIG. 9 is a view of an ophthalmic lens according to one example.

FIG. 10 is a view of an ophthalmic lens according to one example.

FIG. 11 is a view of an ophthalmic lens according to one example.

FIG. 12 is a view of a plurality of microlenses according to one example.

### DETAILED DESCRIPTION

It will be appreciated by persons skilled in the art that the present disclosure is not limited to what has been particularly shown and described herein. A variety of modifications and variations are possible in view of the teachings herein without departing their scope, spirit, or intent.

While different examples may be described in this specification, it is specifically contemplated that any of the features from the different examples can be used and brought together in any combination. In other words, the features of different examples can be mixed and matched with each other. Hence, while every permutation of features from different examples may not be explicitly shown or described, it is the intention of this disclosure to cover any such combinations, especially as may be appreciated by one of skill in the art.

The terminology used in this disclosure should be interpreted in a permissive manner and is not intended to be limiting. In the drawings, like numbers refer to like elements. Unless otherwise noted, all of the accompanying drawings are not to scale. Unless otherwise noted, the term “about” is defined to mean plus-or-minus 5% of a stated value.

In any of the examples of this specification, the term microlens may include an area located on a surface of a larger ophthalmic lens that acts as a smaller lens that focuses light to a location or length different from the large ophthalmic lens. The microlens may be composed of the same material or different material as the larger ophthalmic lens. The microlens may be raised from a surface of the larger ophthalmic lens. The microlens may have a rounded, convex, or similar shape that focuses light to a location or length different than that of the larger ophthalmic lens. The microlens may have different coatings relative to the larger ophthalmic lens.

One aspect of the present invention is directed to a device that includes an array of microlenses to manage or treat amblyopia, as well as a method of using the device, and a method of making the device. More specifically, the device may be eyeglasses or spectacles, including prescription or non-prescription eyeglasses and sunglasses of a variety of different materials and coatings (e.g., plano lenses, single finished vision lenses, semi single finished vision lenses, clear lenses, photochromic lenses, multifocal lenses, and antireflective lenses). The lenses may have a variety of different indexes of refraction, such as 1.50, 1.53, 1.59, 1.60, 1.67, or 1.74.

The eyeglasses may be configured such that a first ophthalmic lens with a microlens array is positioned in front of a wearer's “strong” eye (i.e., the eye that properly moves, tracks, and focuses on a desired target). The microlens array includes a plurality of individual microlenses that are configured to transmit light in a manner out of focus to the wearer, thereby blurring the image to the strong eye. Optionally, the first ophthalmic lens may include a prescription curvature or no prescription curvature, depending on the needs of the wearer. A second ophthalmic lens does not include the microlens array and instead is configured to transmit light in focus to the user's “weak” eye (i.e., the eye that does not move or track properly with the strong eye). This second ophthalmic lens may include a prescription curvature or may include no prescription curvature, depending on the needs of the wearer.

The blur caused by the first ophthalmic lens will penalize the strong eye while encouraging the weak eye to improve in the wearer's desired movement, similar to the use of an eye patch. The blur would be significant to the wearer but have significantly better aesthetics/cosmetics, especially when compared to an eye patch or similar device. Since amblyopia is frequently treated in young children, the improved aesthetics/cosmetics may reduce the likelihood of embarrassment and bullying common with eye patches and occlusion filters.

The array of microlenses can be located on the front side, the back side, or both sides of an ophthalmic lens. Additionally, the array of microlenses may cover the entire visible front and/or back side surface of the ophthalmic lens or may only extend over an area used for direction vision, peripheral vision, or both. For example, the array may not fully extend to the edges of the ophthalmic lens, leaving a space without any microlenses. The array of microlenses may also be configured into a shape (circle, square, triangle, rectangle, etc.), a repeating pattern, or such that the presence and absences of microlenses create a faint picture (e.g., a smiling face, cartoon character, text, etc.). In some examples, the microlenses may comprise repeating patterns of rings, filled circles, triangles, squares, grids, random or stochastic patterns, spirals, checkerboard patterns, clustered patterns, fractal patterns, triangular lattices, honeycomb patterns, or similar shapes/patterns. While any such pattern or picture may be relatively difficult to perceive, it may also provide amusement, acceptance, and reduce embarrassment, particularly in use with children.

The microlenses of an array may be configured to cause out of focus light for the user, thereby making images appear as a blur. This blur can result in a positive or negative focusing power.

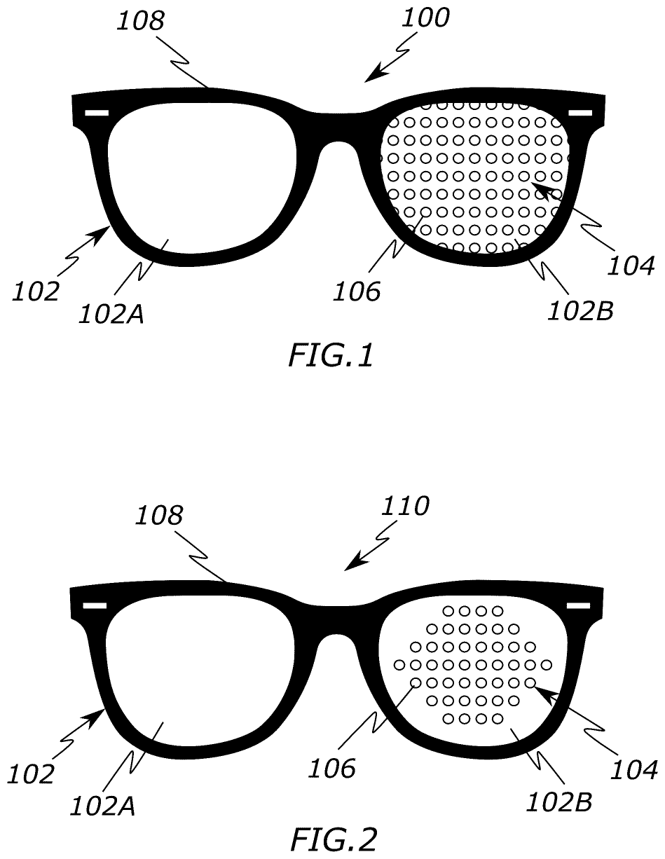

FIG. 1 illustrates one example of eyeglasses 100 configured to manage or treat amblyopia with an array 104 of microlenses 106. The eyeglasses 100 include a frame 108 configured to support two ophthalmic lenses 102. A first ophthalmic lens 102A is configured to provide the wearer with clear/focused viewing (e.g., no prescription or a prescription curvature) along with any further options common to ophthalmic lenses (e.g., antireflection, photochromic, and/or sunglass shading). A second ophthalmic lens 102B may be similarly configured to the first ophthalmic lens 102A but further includes an array 104 of microlenses 106. These microlenses 106 may be on the front surface, back surface, or both surfaces of the ophthalmic lens 102B.

In the present eyeglasses 100, the array 104 extends across the entire surface of the ophthalmic lens 102B. Alternately, FIG. 2 illustrates similar eyeglasses 110 with an array 104 that does not extend entirely to the edge of the ophthalmic lens 102B, leaving a space with some or all of the edges of the ophthalmic lens 102B.

Note that while the ophthalmic lenses 102 are depicted in a specific left/right configuration, their positions may also be swapped. In other words, the ophthalmic lens 102B may be on either the left or right side of the eyeglasses 100/110.

The microlenses 106 may be positioned such that they are in direct contact with each other (e.g., some or all sides of the microlenses 106 directly contact each other) or the microlenses 106 may be spaced apart from each other (e.g., within an inclusive range of about 0.01 mm to 15 mm).

Where the microlenses 106 are spaced apart from each other and not in direct contact, in some examples, the area of the microlenses 106 to areas without the microlenses 106 within an inclusive range of about 0% to about 50%. In some examples, the area of the microlenses 106 to areas without the microlenses 106 within an inclusive range of about 0% to about 12% (e.g., about 0, 1, 2, 3, 4, 5, 6, 7, 8, 9, 10, 11, 12%).

In use, the patient is diagnosed with an eye condition which causes one eye to be weaker or improperly track with the other eye (e.g., amblyopia). The patient is provided with eyeglasses or spectacles in which one ophthalmic lens includes an array of microlenses that blur the vision of patient and another ophthalmic lens that provides substantially clear sight to the patient (i.e., either with or without a prescription). The ophthalmic lens with the array of microlenses is positioned in front of the stronger or properly functioning eye (non-amblyopic eye) and the other ophthalmic lens without the array of microlenses is positioned in front of the weaker or improperly tracking eye (amblyopic eye). These eyeglasses are worn by the user for a predetermined period of time and/or until the patient's eye condition improves to a desired level. For example, the patient may wear the glasses for several weeks or several months.

Another aspect of the present specification is directed to a device that includes an array or plurality of groups of microlenses to manage or treat dry eyes by inducing blinking, as well as a method of using the device and a method of making the device. More specifically, the device can be eyeglasses or spectacles, including prescription eyeglasses and sunglasses of a variety of different materials and coatings (e.g., polycarbonate single finished vision lenses, polycarbonate semi single finished vision lenses, clear lenses, photochromic lenses, and antireflective lenses).

The eyeglasses are configured such that one or both of its ophthalmic lenses include one or more groups of microlenses. These groups of microlenses are sized such that they appear similar to floaters within the ocular fluid of an eye without substantially impacting the user's vision. When the microlenses come into view of the user, depending on the direction of the eye, they induce a blink response in the user's eyes. Since blinking tends to restore the tear film over an eye, the increased rate of blinking may, in some circumstances, improve the moisture level of a user's eyes and reduce any conditions associated with dry eyes.

The device may be eyeglasses or spectacles, including prescription or non-prescription eyeglasses and sunglasses of a variety of different materials and coatings (e.g., polycarbonate single finished vision lenses, polycarbonate semi single finished vision lenses, clear lenses, photochromic lenses, and antireflective lenses). The groups of microlenses may be on only one ophthalmic lens or on both ophthalmic lenses of eyeglasses.

The groups of microlenses may be in nearly identical relative positions on each ophthalmic lens such that both eyes encounter a group of microlenses when looking in certain directions. Alternatively, the groups of microlenses may be in different relative positions on each ophthalmic lens such that only one eye might encounter a group of microlenses when looking in certain directions.

Each ophthalmic lens may include as few as a single microlens group or a plurality of groups (e.g., 1, 2, 3, 4, 5, 6, 7, 8, 9, 10 or more). Depending on the sizes of the groups and the microlenses, as many as 100 or more groups can be included on an ophthalmic lens.

Each group of microlenses may include one or more microlenses. For example, 1, 2, 3, 4, 5, 6, 7, 8, 9, 10, or more microlenses may be included in a group. Each group on an ophthalmic lens may include the same number of microlenses or may include different numbers of microlenses. For example, it may be beneficial to have relatively larger groups of microlenses either closer to the periphery of the user's vision or closer to the user's central vision. In one example, a group includes 2-10 microlenses.

Microlenses that are part of a group may be located a distance from each other within an inclusive range of 1-15 mm. Each group of microlenses may be any distance from each other (e.g., 1 mm to 10 cm) so long as the distance and frequency of the groups do not significantly impact the vision of the user. The microlenses may also have a variety of different sizes, such as within an inclusive range of about 0.50 to 3.14 mm, within an inclusive diameter range of about 0.8 to 2.0 mm, and/or within an inclusive range of about 0.25 to 2.0 mm. The distance between center points of adjacent microlenses may be a distance within an inclusive range of about 0 to 2.0 mm.

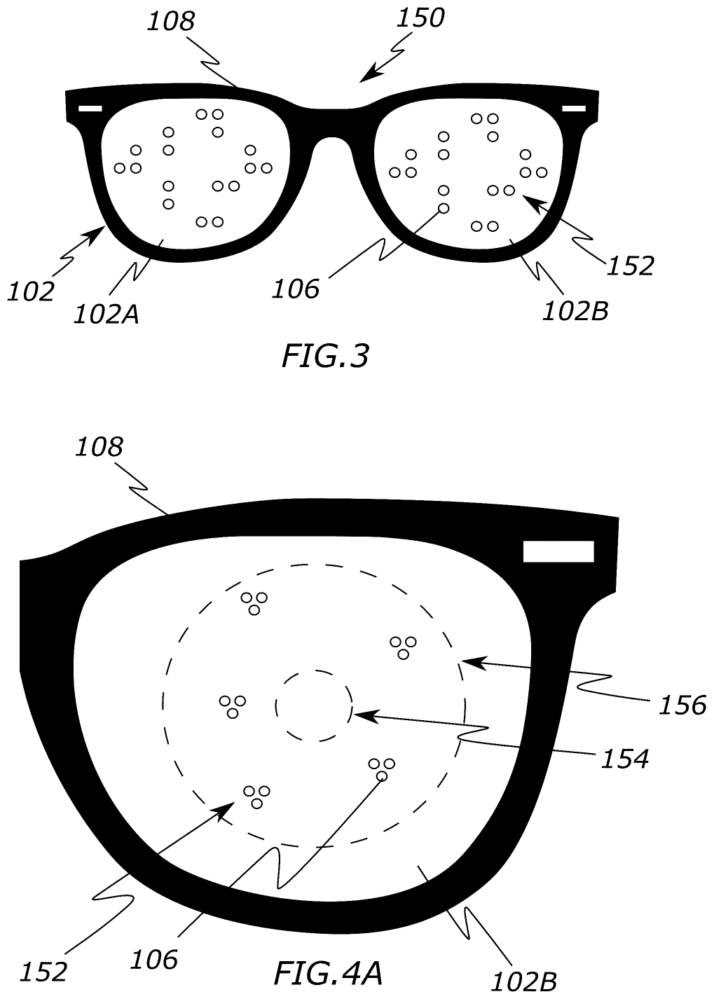

FIG. 3 illustrates one specific example of eyeglasses 150 configured to induce a blink response and to increase or refresh tear film on one or more eyes of a user. The eyeglasses 150 are generally similar to those of previously described example eyeglasses 100, including an eyeglass frame 108 configured to retain or connect to two ophthalmic lenses 102 (102A, 102B). Both ophthalmic lenses 102A, 102B are depicted with a plurality of groups 152 of microlenses 106, though they may only to be included on one of the ophthalmic lenses 102. In the present example, the plurality of groups 152 of microlenses 106 may be located at various locations over the entire lens, such as a center region and peripheral region around the center region. Hence, a blink response may be generated when the wearer is looking through a center area or peripheral area of the lenses 102.

In some examples, the sizes of these groups may help each of the groups appear as floaters in the eyes of the wearer and therefore induce a blink response. For example, each group 152 may have a size within an inclusive range of about 6 mm to about 25 mm.

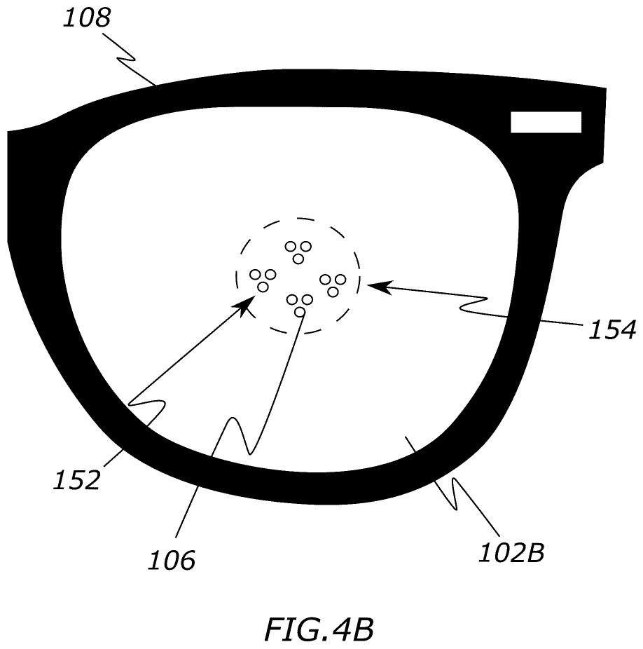

FIG. 4A illustrates an enlarged view of another example of an ophthalmic lens 102B. In the present example, the groups 152 of microlenses 106 are positioned in a ring-shaped area 156 while a central area 154 is free from the groups 152. This configuration allows clear vision when the wearer is looking straight ahead, but when looking off-center, the user will encounter the groups 152 and generate a blink response. While the ring-shaped area 156 is shown with a circular shape, other irregular and/or non-circular shapes are also possible.

FIG. 4B illustrates an enlarged view of another example of an ophthalmic lens 102B in which the groups 152 of microlenses 106 are positioned only in the central area 154. This configuration may generate a blink response when looking forward through the central area 154 but not when looking off-center or through peripheral areas of the lens 102B.

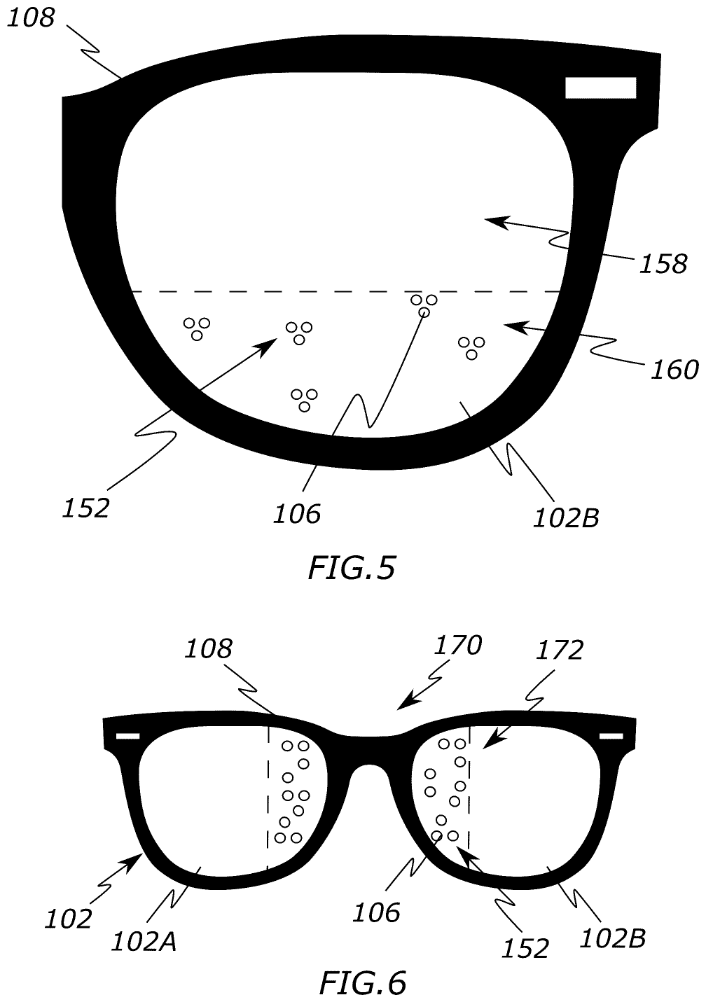

Other locations for the groups 152 are also possible. For example, FIG. 5 illustrates an ophthalmic lens 102B divided into an upper portion 158 (e.g., an upper half) and a lower portion 160 (e.g., a lower half). This may be a standard prescription or non-prescription lens, or may be a lens with different prescriptions, such as a bifocal or trifocal lens. In the present example, the groups 152 of microlenses 106 are located only in the lower portion 160 while the upper portion 158 is free of the groups 152. Hence, a blink response may be generated when the user is looking downwards. This may be particularly helpful for activities such as reading or viewing a computer screen, which are sometimes associated with reduced blinking and dry eyes. Alternately, the groups may only be located in the upper portion 158 while the lower portion 160 is free of the groups 152.

In another example, FIG. 6 illustrates eyeglasses 170 with lenses 102 in which inner side portions 172 include the groups 152 and outer side portions are free from the groups 152, where inner and outer is relative to a wearer's nose or a middle of the frames.

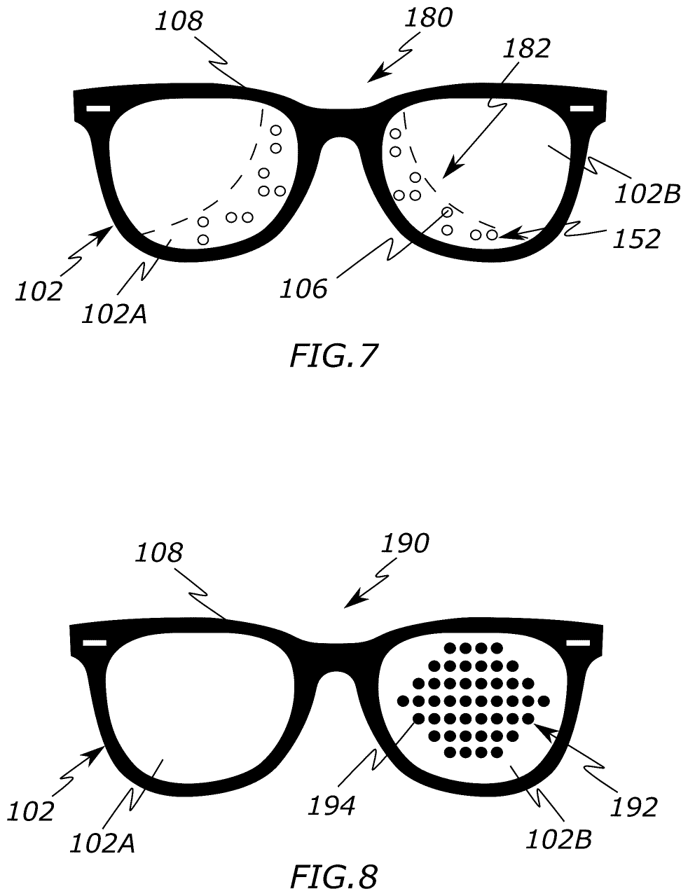

In another example, FIG. 7 illustrates eyeglasses 180 with lenses 102 in which area 182 extends along inner side portions and lower portions of the lenses 102, where inner and outer is relative to a wearer's nose or a lateral middle of the frames. Areas 182 may include the groups 152 while the remaining upper/outer portions are free from the groups 152.

In use, eyeglasses with one or more ophthalmic lenses having one or more groups of microlenses are provided to a user to wear. These eyeglasses may be worn at all times (except for sleeping) or may be worn only during certain activities, such as reading or viewing a computer screen.

The microlenses and the ophthalmic lenses they are located on may be manufactured in a variety of different techniques, such as those in U.S. Pat. Nos. 11,029,540, 10,386,654, and JP App. No. 2023-055747, which are incorporated herein by reference.

One aspect of the present specification is directed to a spectacle or eyeglass lens comprising a first refraction area having a first refractive power based on a prescription for correcting an abnormal refraction of an eye; and a plurality of second refraction areas, each having a refractive power different from the first refractive power, and having a function of focusing an image on a position other than a retina of the eye so as to suppress a progress of the abnormal refraction of the eye, wherein the second refraction areas are dispersedly arranged as a plurality of mutually separate areas, and wherein each of the plurality of second refraction areas is surrounded by the first refraction area. The eyeglass lens may include a ratio of total area of the plurality of second refraction areas, with respect to the total areas of the plurality of second refraction areas and the first refraction area, that is within an inclusive range of about 20 to 60%. The eyeglass lens may have a surface of each of the plurality of second refraction areas that is formed as a convex or concave shape, with respect to a surface of the first refraction area, at an object side of the spectacle lens.

The eyeglass lens may further include a lens substrate having a front optical surface and a back optical surface; and a thin film molded with the spectacle lens substrate, the thin film comprising a first array of microlenses, where each microlens of the first array of microlenses comprising a substantially same focal point and formed of a plurality of layers of different materials having different refractive indices relative to one another. The first array of microlenses may comprise microlenses formed of a material layer having a refractive index in an inclusive range of about 1.8 to 2.1. For example, the microlenses may have a refractive index of about 1.50, 1.53, 1.59, 1.60, 1.67, or 1.74. The first array of microlenses may comprise a different material from which the ophthalmic lens substrate is formed.

Any of the eyeglasses and lenses described in this specification may also be used with ophthalmic dyes, scattering centers, and/or meta structures to selectively absorb, scatter, and/or change focus of specific wavelengths.

The ophthalmic dyes, scattering centers, and/or meta structures may be used in place of the previously described microlenses (i.e., relatively small, discrete locations), in relatively small microlens-sized areas with other microlenses (e.g., areas that contain both), in areas surrounding and/or adjacent to microlenses, within the microlenses (e.g., dyes within the microlenses), or within both the microlenses and areas surrounding and/or adjacent to the microlenses.

For example, FIG. 8 illustrates eyeglasses 190 with an array 192 of areas 194. These areas 194 are of similar size as the previously described microlenses and can be in any configuration previously described for the microlenses, but the areas 194 are instead or additionally composed of ophthalmic dyes, scattering centers, and/or meta structures.

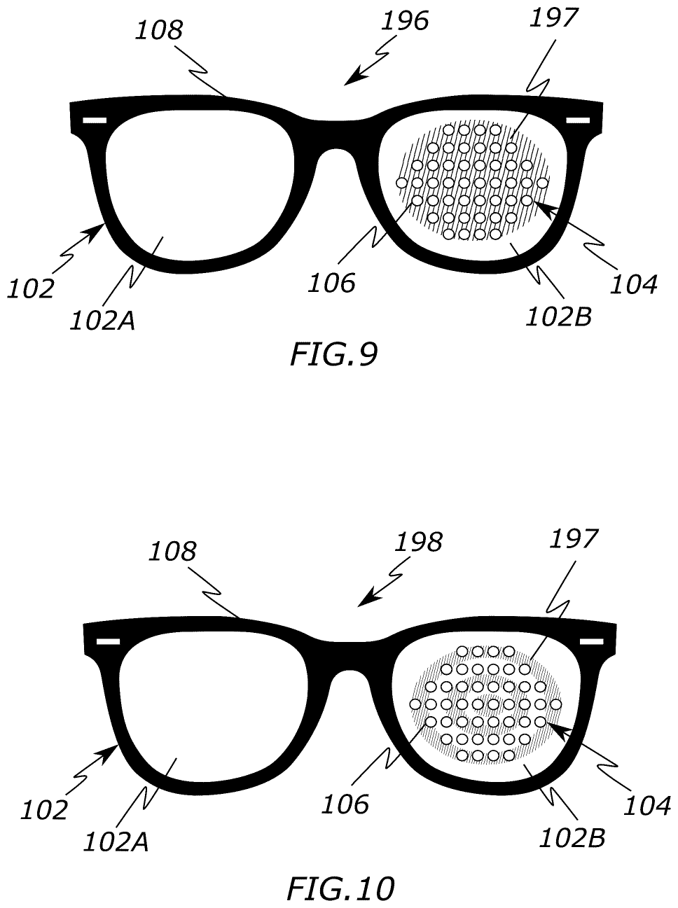

In another example, FIG. 9 illustrates eyeglasses 196 having an array 104 of microlenses 106 according to any of the previously described examples, but further includes a larger area 197 of ophthalmic dyes, scattering centers, and/or meta structures that surround the microlenses 106. The larger area 197 may be located around some or all of the array 104.

The eyeglasses 198 of FIG. 10 are similar to those of eyeglasses 196 but the area 197 may form a shape or pattern, such as the bullseye shape (i.e., a plurality of circular shapes within each other) seen in the figure. Other shapes are also possible.

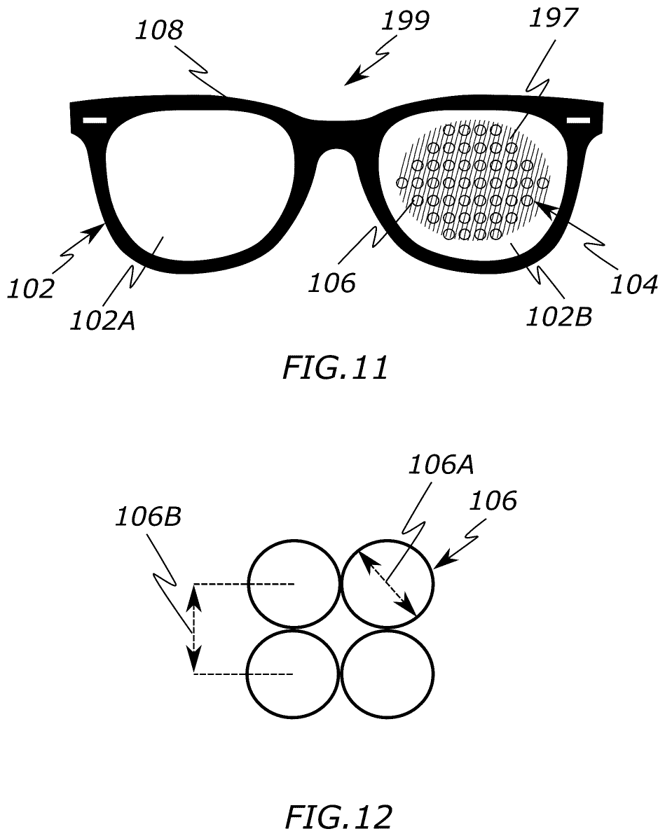

In another example, the eyeglasses 199 of FIG. 11 are similar to eyeglasses 196 and 197 but the area 197 of ophthalmic dyes, scattering centers, and/or meta structures may be also located underneath and/or within the microlenses 106 (e.g., within the material of the first ophthalmic lens 102 and/or the material of the microlenses 106).

In any of the examples of this specification, the surface area coverage density of the microlenses may be within an inclusive range of about 20-80% of the total lens surface.

In any of the examples of this specification, the ophthalmic dye may be applied as a coating to a lens. Further, the ophthalmic dye coating may be applied at a non-perpendicular angle relative to the surface of the lens (e.g., within an inclusive range of about 45 degrees to about 2 degrees). Depending on the application angle, the microlenses 106 may only be covered by the coating while the surrounding area will be mostly avoided. This spray angle may be applied from several different rotational positions so as to cover all sides of the microlenses 106. Alternatively, ophthalmic dye may be applied (e.g., as a coating) to the entire lens prior to the creation of the microlenses 106 such that the later-added microlenses 106 do not include the ophthalmic dye, or the ophthalmic dye may be applied as a coating in a way that only covers the areas of the lens surrounding the microlenses 106, thereby leaving the microlenses 106 substantially free of the ophthalmic dye.

In any of the examples of this specification, the surface area coverage density of the microlenses may be within an inclusive range of about 20-80% of the total lens surface to control the extent of the defocus.

FIG. 12 illustrates a top view of a plurality of microlenses 106 that each have a diameter 106A and a distance 106B between center points of adjacent microlenses 106. In any of the examples of this specification, the microlenses may have a variety of different diameters 106A, such as within an inclusive range of about 0.50 to 3.14 mm, within an inclusive diameter range of about 0.8 to 2.0 mm, and/or within an inclusive range of about 0.25 to 2.0 mm. The distance 106B between center points of adjacent microlenses may be a distance within an inclusive range of about 0 to 10.0 mm, 0 to 5.0 mm, and/or 0 to 2.0 mm. A gap or spacing between closest points of adjacent microlenses 106 may be within an inclusive range of about 0 to 2.0 mm.

In any of the examples of this specification, the ratio of the area of a lens 102 without any microlenses 106 to the area of the lens 102 with microlenses 106 may be within an inclusive range of 0 percent to 50 percent, 0 percent to 25 percent, or 0 percent to 15 percent. In some examples, this ratio is about 12 percent, plus-or-minus 2 percent.

In any of the examples of this specification, the microlenses 106 may have a defocus power that achieves a visual acuity value of about 0.3 or less, and in some examples, 0.1 or less.

In any of the examples of this specification, the microlenses may be configured to focus or defocus light at specific positions different from the retina of the user.

In any of the examples of this specification, the microlenses may have a convex shape.

In any of the examples of this specification, the microlenses may have a spherical shape or an aspherical shape.

In any of the examples of this specification, the entire plurality of microlenses may include several different sizes (e.g., diameters), spacings from each other, patterns, or any of the other features discussed in this specification.

While an eyeglass frame 108 is primarily described in this specification, it should be understood that other types of frames or ophthalmic lens support arrangements may be possible. For example, goggles, visors, monocles, helmets, or similar frames/arrangements are possible. Hence, while the term “frame” may be used, it should be understood to be inclusive of any type of structure that may support an ophthalmic lens unless otherwise specified. While the examples of this specification illustrates two discrete lenses (e.g., a first ophthalmic lens 102A and an ophthalmic lens 102B), it may also be understood to cover single lens equivalents that cover both eyes of a user, such as goggles, single lens eyeglasses, helmet visors, and similar arrangements.

In any of the examples of this specification, the microlenses may be located on a front surface of the lens 102, a back surface of the lens 102, both the front and back surfaces of the lens 102, or between layers or within material of the lens 106.

In any of the examples of this specification, the term microlens may be synonymous with the term lenslet.

In any of the examples of the specification, the term ophthalmic lens assembly may include at least one lens comprising a plurality of microlenses, and may optionally further include a second lens and a frame (e.g., an eyeglass frame).

In any of the examples of this specification, eye shape and/or growth may be additionally affected by wavelength (and therefore color) selective filters may further be used. For example, wavelength selective filters or scattering centers may be utilized to absorb or defocus select wavelength (and therefore color). In a specific example, the wavelength selective filters include a color specific ink or dye. In another example, selective scattering centers are utilized to defocus specific wavelengths using core-shell particles. In another example, selective scattering centers are utilized to focus or defocus specific wavelengths using meta structures.

1. An ophthalmic lens assembly for managing eye conditions, comprising:
a first ophthalmic lens comprising a plurality of microlenses integrated with the first ophthalmic lens; where each of the plurality of microlenses modify a focus of light; and,
a frame connected to the first ophthalmic lens; wherein the frame positions the plurality of microlenses substantially in front of only a first eye of a user and wherein the plurality of microlenses defocus light relative to a retina of the first eye of the user.

2. The ophthalmic lens assembly of claim 1, wherein the plurality of microlenses is configured to focus light closer to a front side of a user's retina to reduce visual acuity.

3. The ophthalmic lens assembly of claim 1, wherein the plurality of microlenses is configured to focus light further from a front side of a user's retina to reduce visual acuity.

4. The ophthalmic lens assembly of claim 1, wherein the plurality of microlenses is arranged in repeating patterns, where each of the repeating patterns comprise a ring shape, a filled circle shape, a filled triangle shape, or a filled square shape.

5. The ophthalmic lens assembly of claim 1, wherein the plurality of microlenses are arranged in a grid pattern, a random or stochastic pattern, a spiral pattern, a checkerboard pattern, a clustered pattern, a fractal pattern, a triangular lattice pattern, or a honeycomb pattern.

6. The ophthalmic lens assembly of claim 1, wherein the plurality of microlenses have a diameter within an inclusive range of about 0.25 to 2.0 mm.

7. The ophthalmic lens assembly of claim 1, wherein at least some of the plurality of microlenses are spaced apart from each other at a distance of about 0 to 2.0 mm measured from center points of the plurality of microlenses.

8. The ophthalmic lens assembly of claim 1, wherein a ratio of an area of the first ophthalmic lens without the microlenses to the area of the first ophthalmic lens without the microlenses is within an inclusive range of about 0 percent to 25 percent.

9. The ophthalmic lens assembly of claim 1, wherein a ratio of an area of the first ophthalmic lens without the microlenses to the area of the first ophthalmic lens without the microlenses is about 12 percent, plus-or-minus 2 percent.

10. The ophthalmic lens assembly of claim 1, wherein the plurality of microlenses are each configured to have a defocus power achieving a visual acuity value of 0.3 or less.

11. The ophthalmic lens assembly of claim 1, wherein the plurality of microlenses are each configured to have a defocus power achieving a visual acuity value of 0.1 or less.

12. The ophthalmic lens assembly of claim 1, wherein the plurality of microlenses include spherical shaped microlenses, aspherical shaped microlenses, or a combination of both.

13. The ophthalmic lens assembly of claim 1, wherein the plurality of microlenses are located on a front surface of the first ophthalmic lens, a back surface of the first ophthalmic lens, both the front and back surfaces of the first ophthalmic lens, between layers of the first ophthalmic lens, or within material of the first ophthalmic lens.

14. The ophthalmic lens assembly of claim 1, further comprising a second ophthalmic lens connected to the frame; wherein the second ophthalmic lens is free of any microlenses.

15. The ophthalmic lens assembly of claim 14, wherein the frame is configured to position the first ophthalmic lens in front of a stronger eye of a wearer and wherein the second ophthalmic lens is positioned in front of a weaker amblyopic eye of the wearer.

16. The ophthalmic lens assembly of claim 1, further comprising a second ophthalmic lens connected to the frame; wherein the plurality of microlenses is part of both the first ophthalmic lens and the second ophthalmic lens.

17. The ophthalmic lens assembly of claim 16, wherein the plurality of microlenses is arranged in a plurality of groups of microlenses on the first ophthalmic lens and the second ophthalmic lens.

18. The ophthalmic lens assembly of claim 17, wherein the plurality of groups of microlenses have a size within an inclusive range of about 6 mm to about 25 mm.

19. The ophthalmic lens assembly of claim 17, wherein the plurality of groups of microlenses are arranged in a ring shape on the first ophthalmic lens and the second ophthalmic lens.

20. The ophthalmic lens assembly of claim 17, wherein the plurality of groups of microlenses are arranged on only a lower half of the first ophthalmic lens and the second ophthalmic lens.

21-49. (canceled)
